(19) United States
(12) Patent Application Publication
(10) Pub. No.: US 2008/0303525 A1
(43) Pub. Date: Dec. 11, 2008

(54) SINGLE-DIPOLE HIGH FREQUENCY ELECTRIC IMAGER

(75) Inventors: Gregory B. Itskovich, Houston, TX (US); Alexandre N. Bespalov, Spring, TX (US); Stanislav W. Forgang, Houston, TX (US); Randy Gold, Houston, TX (US); Tsili Wang, Katy, TX (US)

Correspondence Address: CANTOR COLBURN LLP- BAKER ATLAS, 20 Church Street, 22nd Floor, Hartford, CT, 06103, US

(73) Assignee: BAKER HUGHES INCORPORATED, Houston, TX (US)

(21) Appl. No.: 11/758,875

(22) Filed: Jun. 6, 2007

(51) Int. Cl. G01V 3/00

(52) U.S. Cl. 324/351

(57) ABSTRACT

A single-dipole sensor for determining an electrical property of an earth formation, includes a pad consisting essentially of a body and at least one small electrode separated from a large electrode by an insulator; wherein an output of the sensor includes a measurement of an electrical signal through the formation for each small electrode. A method for using the sensor is included, as well as a method for providing images of the earth formation.

### BACKGROUND OF THE INVENTION

1. Field of the Invention

The invention disclosed herein relates to subterranean imaging and, in particular, to an electrode for resistivity imaging within a wellbore.

2. Description of the Related Art

Imaging of formations surrounding boreholes provides valuable information for describing geologic features. Some of the features include structural framework, fracture patterns, sedimentary feature, and in-situ stress orientation. High-resolution borehole images are used as an aid in providing conventional core description and determining orientation. Information obtained using such image is also useful for determining aspects of formation testing, sampling, perforating and other such tasks. For thinly laminated turbidite sands and other sequences, these images are often one of the few practical methods for determining net sand and deposit thicknesses.

A particular challenge has been obtaining micro-resistivity images in wells drilled with oil-based (commonly referred to as “non-conductive”) muds. Various tools have been devised to provide borehole images from wells having oil-based muds.

One instrument for making resistivity measurements in non-conductive mud is available from Baker Hughes, Incorporated of Houston, Tex. The instrument, referred to as an “Earth Imager,” has provided for resistivity images in wells drilled with non-conductive muds.

In some embodiments, the instrument includes six separate pads with each pad including various electrodes. A known voltage difference between a return electrode and the pads is used to create a current flow through the formation being imaged. The return electrode and the pads are separated by an electrical isolator.

Each pad may contain a set of eight measuring sensor electrodes surrounded by a metal pad housing which acts as a focusing electrode for the measuring sensor electrodes. Control circuitry maintains a zero voltage difference between the focusing electrode and the measuring sensor electrodes. This configuration forces current I from the measuring sensor to flow into the formation perpendicular to the instrument near the pad face. This practice is commonly known as current focusing.

The current measurement for each measuring sensor electrode is a function of the formation conductivity and the voltage applied. High resolution images are achieved by sampling at a high rate (for example, about 120 samples per foot), using the readings from the forty eight sensor electrodes mounted on the six pads.

These measurements are scaled to resistivity values so that they can be correlated with conventional shallow measurements. Each measurement acquired is corrected for speed variations and oriented to true North using magnetometer and accelerometer readings from a separate orientation instrument prior being presented as a color, scaled resistivity image.

This instrument has provided improved vertical resolution and borehole coverage when compared to other systems. With the advent of the instrument, making use of resistivity image data for structural, sedimentological and petrophysical analyses became possible for wells having oil-based mud.

However, the growing use of oil-based mud systems provides an environment that precludes the use of conventional micro-resistivity wellbore imaging. Many operators have considered that drilling and wellbore stability efficiencies associated with using oil-based muds outweigh the lost benefits of having micro-resistivity images.

Reference may be had to FIG. 1. In FIG. 1, there is shown a depiction of the prior art instrument for performing resistivity imaging in oil based muds. In this example, the instrument 20 is disposed within a wellbore 11. The instrument 20 includes pads 3 mounted on articulating arms 2. The articulated pads 3 are typically pressed firmly against a wall of the wellbore 11. Current I flows from the return electrode 4 to the pads 3. The return electrode 4 is electrically separated from each of the pads 3 by an isolator 5.

In some embodiments, the instrument 20 operates in non-conductive muds and provides a current having a frequency f of about 1 MHz. At this frequency f, the capacitive impedance Z_{c} of the non-conductive mud becomes a finite value and may be determined. Capacitive impedance Z_{c} may be determined by Eqs. 1 and 2:

Z_{c}=k(1/(f×C)) Eq. (1),

where:
f represents the frequency;
C represents capacitor equivalence between the electrodes and formation through displacement currents;
k represents a constant;

Z_{c}=V/I(m)−R Eq. (2),

where:
V represents a known and constant voltage;
I(m) represents measured current at a sensor electrode; and
R represents resistor equivalence for losses in the formation due to finite conductivity.
   At a high frequency f the capacitive impedance Z_{c} becomes very small, hence, Eq. 3 is realized:

R=k (V/I(m)) Eq. (3).

Referring also to FIG. 2, aspects of the prior art pad 3 in relation to a formation 10 are depicted. In FIG. 2A, aspects of current distribution in the formation 10 are shown. In FIG. 2B, aspects of capacitive coupling between the pad, the non-conductive mud, and the formation 10 are shown.

Although prior embodiments of the instrument 20 provide electrical conductivity measurements of a quality previously available only in water-based mud systems, the never-ending demand for improved technology requires further advancements in image resolution.

Therefore, what is needed is a instrument for providing resistivity imaging in non-conductive muds, where the instrument provides improved resolution and thus quality of images, while having a simplified design for the injection of current into the formation.

### BRIEF SUMMARY OF THE INVENTION

Disclosed is a single-dipole sensor for determining an electrical property of an earth formation, the sensor including: a pad consisting essentially of a body and at least one small electrode separated from a large electrode by an insulator; wherein an output of the sensor includes a measurement of an electrical signal through the formation for each small electrode.

Also disclosed is a method for determining an electrical property of an earth formation, the method including: using a single-dipole sensor including a pad consisting essentially of a body and at least one small electrode separated from a large electrode by an insulator; injecting an electrical signal into the formation; measuring the electrical signal through the formation; and determining the electrical property using the measured signal.

Further disclosed is a single-dipole sensor for determining an electrical property of an earth formation, the sensor including: a pad including a body, at least one small electrode, a large electrode and a shield disposed between the large electrode and the at least one small electrode; wherein an output of the sensor includes a measurement of an electrical signal through the formation for each small electrode.

In addition, a method for providing an image of an earth formation is disclosed and calls for: using a single-dipole sensor including a pad consisting essentially of a body and at least one small electrode separated from a large electrode by an insulator; injecting an electrical signal into the formation; measuring the electrical signal through the formation; and providing the image of the earth formation from the measurements.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a prior art instrument for performing resistivity measurements in a wellbore;

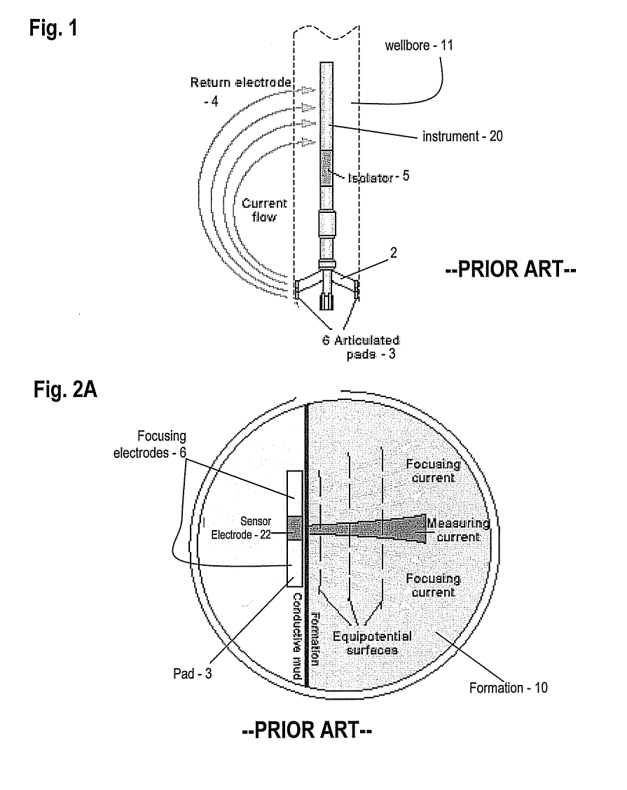

FIG. 2A and FIG. 2B, collectively referred to herein as FIG. 2, depict aspects of operation of the prior art instrument of FIG. 1;

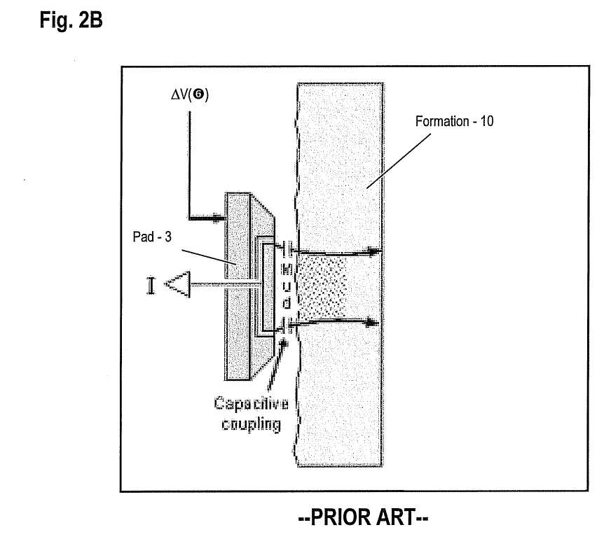

FIG. 3 depicts an exemplary deployment of a high frequency electric imager described herein;

FIG. 4 depicts a first embodiment of the high frequency electric imaging (HFEI) sensor;

FIG. 5 depicts a cross section of the sensor in relation to an anomaly in a formation;

FIG. 6 depicts simulated measurement data for the first embodiment;

FIG. 7 depicts a second embodiment of the high frequency electric imaging sensor;

FIG. 8 depicts a distribution of current where a shield is included in the sensor; and

FIG. 9 provides an exemplary method for using the sensor.

### DETAILED DESCRIPTION OF THE INVENTION

Disclosed is a single-dipole high-frequency electric imaging (HFEI) sensor. The sensor presented herein is used as a component of an HFEI imaging instrument. The imaging instrument is particularly useful for making resistivity measurements when well logging with a non-conductive mud. As discussed herein, logging may include various types of logging as are known in the in art, including wireline logging and measuring-while-drilling (MWD), which may also be referred to as logging-while-drilling (LWD).

For purposes of the discussion herein, the imaging instrument is used during wireline logging (that is, after drilling). However, one skilled in the art will recognize that this is illustrative and not limiting of the teachings herein. For example, aside from wireline deployment, the device may be deployed using coil tubing, a pipe, a drill string, a tractor, or any other technique that is deemed suitable.

As discussed herein, oil-based mud is generally regarded as being “non-conductive.” However, it is recognized that oil-based mud and the variations of drilling mud as may be useful for practice of the teachings herein, are conductive at least to some degree. Accordingly, while the term “non-conductive” may be used herein with regard to oil-based mud and similar drilling fluids, this use is merely indicative of electrical properties and not considered to be limiting of the teachings herein.

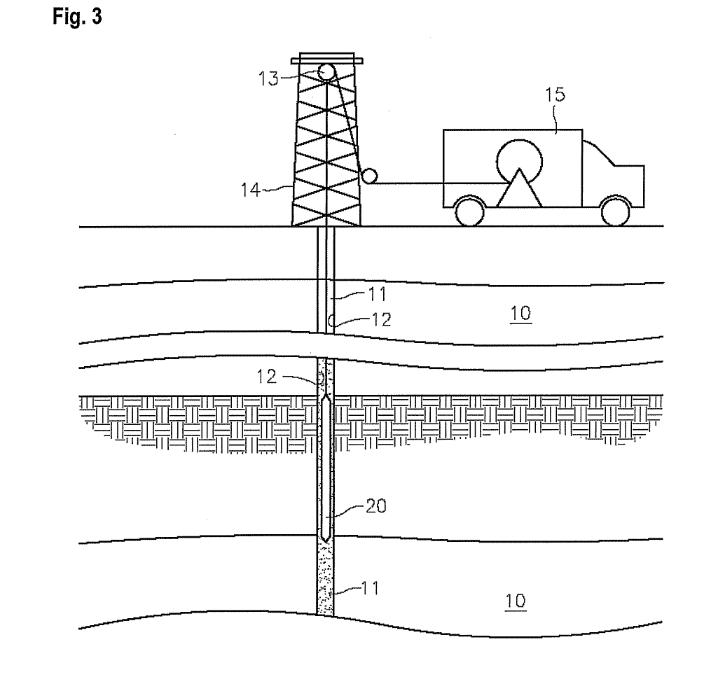

Aspects of logging a well using the instrument disclosed herein are depicted in FIG. 3. In FIG. 3, a cross-section of earth formations 10 along the length of a penetration referred to as a “wellbore” 11 is depicted. Usually, the wellbore 11 is at least partially filled with a mixture of fluids including water, drilling fluid, mud, oil and formation fluids that are indigenous to the formations 10 penetrated by the wellbore 11. Drilling mud may also be introduced into the wellbore 11. In some embodiments, the drilling mud is a non-conductive fluid as is known in the art.

Suspended within the wellbore 11 at the bottom end of a wireline 12 is the HFEI imaging instrument 20. The wireline 12 is often carried over a pulley 13 supported by a derrick 14. Wireline 12 deployment and retrieval is typically performed by a powered winch carried by a service truck 15 or skid (not shown). Aside from deployment by the service truck 15 or the skid, the instrument 20 may be deployed using any other technique that is deemed suitable.

As is known in the art, the HFEI imaging instrument 20 or the service truck 15 include electronics and support equipment to operate the HFEI imaging instrument 20. Included with the electronics and support equipment is a power supply for providing power to the HFEI imaging instrument 20, processing capabilities, data storage, memory and other such components. The power provided to the HFEI imaging instrument 20 may be delivered over a broad range of frequencies f and currents I. Signal analysis may include known techniques for analog signal processing and digital signal processing as appropriate. As these and other aspects are known to those of ordinary skill in the art, such aspects are generally not discussed in greater detail.

A power supply for the sensor 40 provides alternating current (AC) that is in a relatively high frequency f range (for example, of about 1 MHz to about 10 MHz). The sensor 40 may be operated at frequencies above or below this range. For example, the sensor 40 may be operated in ranges from about 1001 kHz to 100 MHz. Alternatively, the sensor 40 may be used with direct current (DC) if desired.

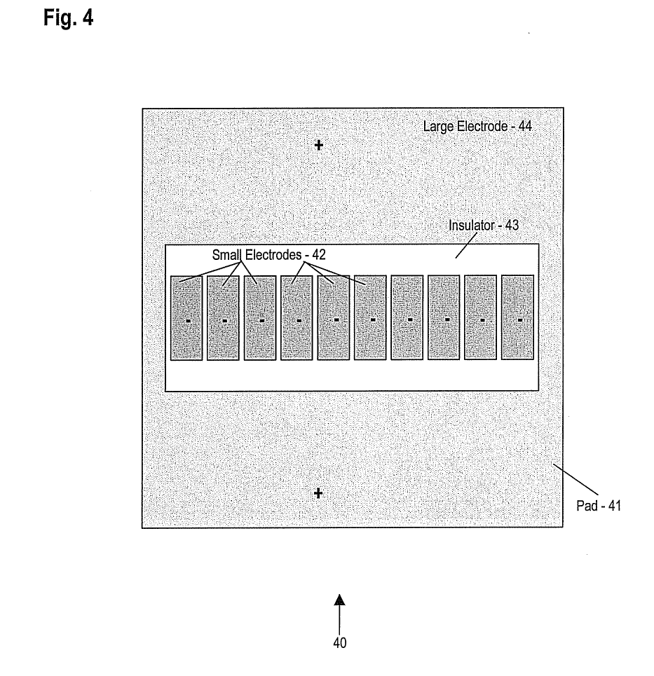

FIG. 4, shows an exemplary and a non-limiting embodiment of a high-frequency electric imaging (HFEI) sensor 40. FIG. 4 depicts a front view of the sensor 40. Accordingly, aspects of the front view are now discussed. However, one skilled in the art will recognize that other salient aspects of the sensor 40 may not be shown in this view. For example, electrical connections to the various electrodes are not shown in FIG. 4. As aspects of electrical connections are known in the art, such aspects are discussed only as appropriate herein to further define operation of the sensor 40.

The sensor 40, as depicted in FIG. 4, is disposed on a pad 41. The sensor 40 may include the entire surface of the pad 3 or some smaller portion of the pad 41. As the sensor 40 is mounted on the pad 41, or integrated into the pad 41, the sensor 40 provides higher resolution images of earth formations 10 than achieved in the prior art.

The HFEI sensor 40 includes at least one small electrode 42. In some embodiments, the small electrodes 42 are referred to as “sensor electrodes” and in other embodiments may be referred to as “button electrodes.” In operation, the large electrode 44 provides for one pole of an electric dipole, while the at least one small electrode 42 provides for the other pole. Accordingly, the sensor 40 makes use of a single electric dipole for high-frequency electric imaging.

In the example of FIG. 4, the at least one small electrode 42 includes ten (10) small electrodes 42. Each electrode is insulated from other electrodes by an insulator 43. Surrounding the insulator 43 is a single large electrode 44. In some embodiments, the large electrode 44 is referred to as a “return electrode.”

While the terms “large” and “small” are used with reference to the various electrodes, these terms are merely illustrative and are not limiting of the teachings herein. For example, one skilled in the art may recognize that, in some embodiments, a collective surface area (or some other physical quantity) for the small electrodes 42 may actually exceed the surface area (or respective other physical quantity) of the large electrode 44. Accordingly, it should be understood that the terminology merely provides for distinction between the types of electrodes.

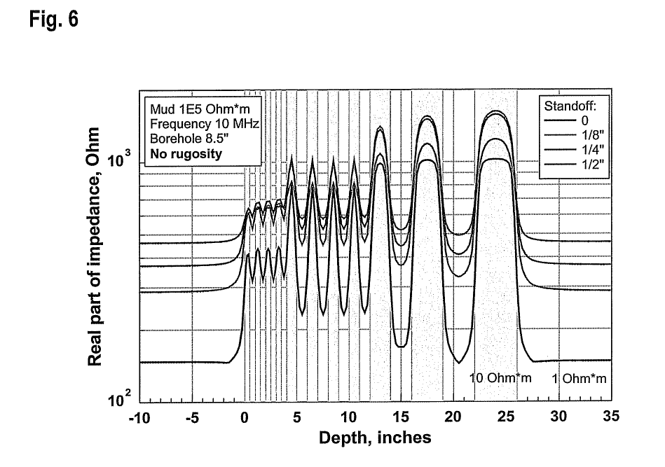

In some other embodiments, the large electrode 44 includes more than one surface. For example, the large electrode 44 may include two separate surfaces that are electrically connected by an electrical connection beneath the surface (such as through a portion of the pad 41). Further, although the large electrode 44 is shown as surrounding the insulator 43, other embodiments may be realized. For example, at least one of the large electrode 44 and the insulator 43 may at least partially surround, or substantially surround the small electrodes 42 (as a further example, reference may be had to FIG. 6).

Each of the at least one small electrodes 42 and the large electrode 44 are formed of conducting material, such as a metal alloy or a metallic material. Current I is measured individually for each of the small electrodes 42 by use of separate current measuring circuits (not shown).

The combination of the small electrodes 42 and the large electrode 44 used in the HFEI sensor 40 provides for a measurement signal that is improved over the prior art. More specifically, in the prior art, current is injected by focusing electrode(s) as well as sensing electrodes, while the current is only measured by the sensing electrodes. Therefore, prior art sensors include sensing electrodes that are adapted for sensing only a portion of the injected current Iᵢ.

In contrast to the prior art, the at least one small electrode 42 of the HFEI sensor 40 senses all of the injected current Iᵢ minus losses through the formation (generally attributed to resistivity of the formation, R_{f}). Accordingly, the teachings disclosed herein provide for improved signal measurements over the prior art. That is, for the HFEI sensor 40, a measured electrical signal (for example, a measured current Iₘ) equates to an injected electrical signal (e.g., injected current Iᵢ) minus losses in the formation (from, for example, resistivity of the formation, R_{f}).

Output of the sensor 40 is not limited to measured current I. Output may include measurement of any electrical signal that is correlated to the earth formations 10. For example, output may include at least one of a measurement of current I, potential V and impedance Z. For convention, such measurements are taken between the large electrode 44 and the at least one small electrode 42, and are necessarily affected by properties of the formation and other materials (such as non-conductive mud) residing between the electrodes. One skilled in the art will understand that while one property may be measured, other related properties may be calculated or otherwise arrived at by employing known relationships and, in some embodiments, making certain assumptions (for example, assumptions may be made regarding electrical properties of non-conductive fluids). Further, one skilled in the art will recognize that other conventions may be employed to accommodate certain measurement techniques.

As an example, while current I may be measured for each of the small electrodes 42, at least one of voltage V and impedance Z may be calculated. In one embodiment, a known voltage V is used for calculation of the impedance Z for the formation 10.

Referring now to the embodiment of FIG. 4 in more detail, the sensor 40 shown includes a series of the at least one small electrode 42 disposed in a linear array. Each of the small electrodes 42 has dimensions that generally match the remaining small electrodes 42. In this example, each of the small electrodes 42 is rectangular in appearance. It should be noted that the illustrations provided herein are merely illustrative and are not limiting of the sensor 40. As examples, the small electrodes 42 may have a circular or other form in appearance as is known in the art. Likewise, the large electrode 44 as well as the insulator 43, each shown with a generally rectangular appearance, may assume other shapes (and sizes).

In the exemplary embodiment of FIG. 4, disposed within a central portion of the large electrode 44 is the insulator 43. The small electrodes 42 are generally evenly distributed within the area of the insulator 43. Each of the small electrodes 42 are separated from the other small electrodes 42 by a width of the insulator 43.

In some embodiments, at least one of the small electrodes 42 is recessed (or protrudes) at least slightly from a surface of the sensor 40. Variations in size of the small electrodes 42 may be had. In embodiments where at least one small electrode 42 is recessed, a dielectric material may be disposed over the recessed small electrode 42. The dielectric material is included to provide for certain modifications to electrical signals associated with the respective small electrode 42, and provide for, among other things, comparisons of measurements between the small electrodes 42 that serve to further describe electrical properties of the formations 10.

Typically, at least one aspect of the electrical signal is measured for each of the small electrodes 42. In some embodiments, the potential V between the small electrodes 42 and the large electrode 44 is maintained in a uniform state using techniques as are known in the art (such as, for example, by implementation of feedback circuits).

Like the small electrodes 42, many aspects of the large electrode 44 may be modified (for example, size, shape and physical relationships with the at small sensor electrodes 42). The modifications may provide for reductions in impedance between the large electrode 44 and the formation 10.

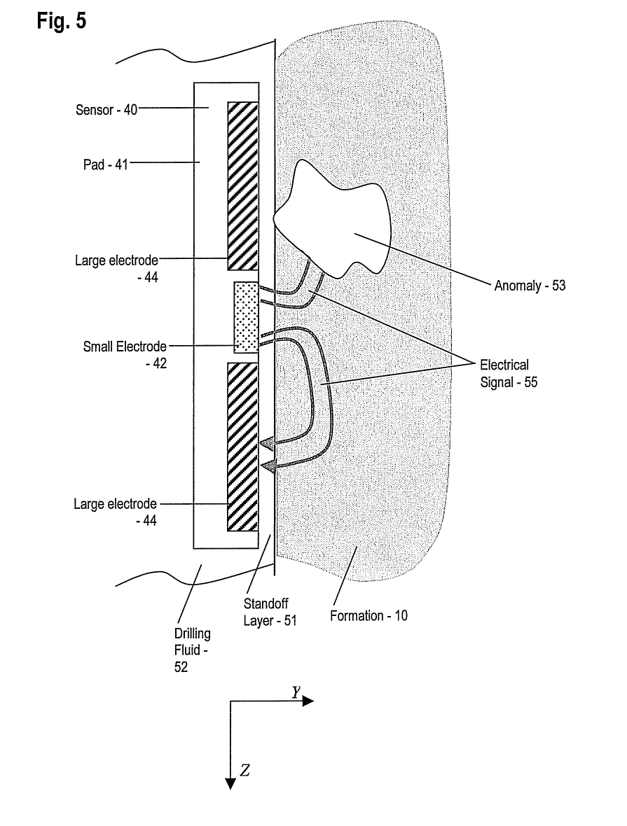

Modification or consideration of physical aspects of the small electrodes 42 and the large electrodes 44 with respect to each other may provide for certain desired performance characteristics. Among other things, spatial sensitivity of the sensor 40 may be manipulated according to a given design. Reference may be had to FIG. 5.

In FIG. 5, a cross section of the sensor 40 is shown, where the sensor 40 is mounted on the pad 41. The cross section depicted is of the sensor 40 shown in FIG. 4. The sensor 40 depicted includes a single large electrode 44 and multiple small electrodes 42. This embodiment of the sensor 40 includes a design for an anomaly 53 within a certain range of sizes. That is, the large electrode 44 or the small electrodes 42 have dimensions that reduce the electrical signal 55. Using certain designs for the electrodes of the sensor 40 may cause the effect of the reduction to be particularly pronounced when the anomaly 53 is near either one of the small electrodes 42 or the large electrodes 44. Accordingly, it may be said that design for the sensor 40 may include consideration of “spatial sensitivity” for evaluating aspects of the formation 10.

Included in FIG. 5 is a depiction of a standoff layer 51. The standoff layer 51, also referred to simply as “standoff 51,” includes a layer of some thickness that is disposed between the formation 10 and the sensor 40. The standoff layer 51 typically includes an oil-based drilling mud 52, and may include other materials, such as mud cake.

In one embodiment (not shown), an exemplary HFEI imaging instrument 20 includes six sensors 40. The sensors 40 are constructed in accordance with the first embodiment provided in FIG. 4. However, other embodiments of the sensor 40 may be used (alone or in combination). In this example, each sensor 40 is disposed on a pad 41 mounted upon an articulating arm 2. Each articulating arm 2 is disposed at about sixty degrees (60°) from another one of the articulating arms 2. This distribution provides for an even distribution about a circumference of the HFEI imaging instrument 20, and complete imaging of formations 10 surrounding the wellbore 11.

Typically, the sensors 40 are pressed against the side of the wellbore 11 when the articulating arms 2 are deployed. One may correctly surmise that standoff 51 can present problems for accurate assessment of formation properties.

The HFEI sensor 40 provides for, among other things, improved sensitivity for measurements of the capacitive impedance Z_{c} and resistivity R_{f} of the formation 10. Improvements over the prior art in the measurements of capacitive impedance Z_{c} are realized by switching from magnitude impedance measurements to phase sensitive impedance measurements. Further, increases in the operating frequency f provide for improved performance in the presence of the standoff 51.

In order to demonstrate performance of the sensor 40 disclosed herein, aspects of the wellbore 11 were modeled and sensor operation was simulated. The modeling and simulation included consideration of standoff 51 as might be encountered in the wellbore 11.

In the simulation, the dynamic range of a signal produced by the sensor 40 was examined by using a benchmark model. The model included a formation 10 having a sequence of conductive layers and resistive layers. The dimensions and arrangement of the sensor 40 were in accordance with those provided in FIG. 4. Results of the simulation are depicted in FIG. 6.

FIG. 6 depicts performance of the sensor 40 and the effect of standoff 51 on a real part of the impedance Z_{c}. In this example, the real part of the capacitive impedance Z_{c} relates to resistivity R_{f} of the formation and resistivity of the mud Rₘ in the standoff 51 (wherein resistivity of the mud Rₘ is about 100,000 Ohm). In FIG. 6, the standoff 51 was modeled as being 12.7 millimeters (½″) thick, a 6.4 millimeters (¼″) thick and 3.2 millimeters (⅛″) thick. The performance was also modeled with no (zero) standoff 51.

As one can see from the data presented in FIG. 6, for the case without standoff 51 and where layers in the formation 10 were thicker than about 76.2 millimeters (3 inches), the dynamic range of the real part of the impedance Z_{c} is equal to about ten (10). This dynamic range is about the same as the true resistivity contrast for the formation 10. The model shows that dynamic range deteriorates for the thin layers and with a standoff increase. However, even where the standoff 51 was about 6.4 millimeters (¼″) and the layers were about 25.4 millimeters (1″) thick, the dynamic range is equal to about two (2).

The sensor 40 according to the teachings herein provides for increasing locality of measured responses by reducing contributions from the background resistivity R_{b} into the measured impedance Z_{c}. This effect is provided by, among other things, using an entire body of the pad 41 (or a significant portion thereof) as the large electrode 44, and having a voltage applied between the body (the large electrode 44) and the small electrodes 42. This design is referred to as an “on-pad return.”

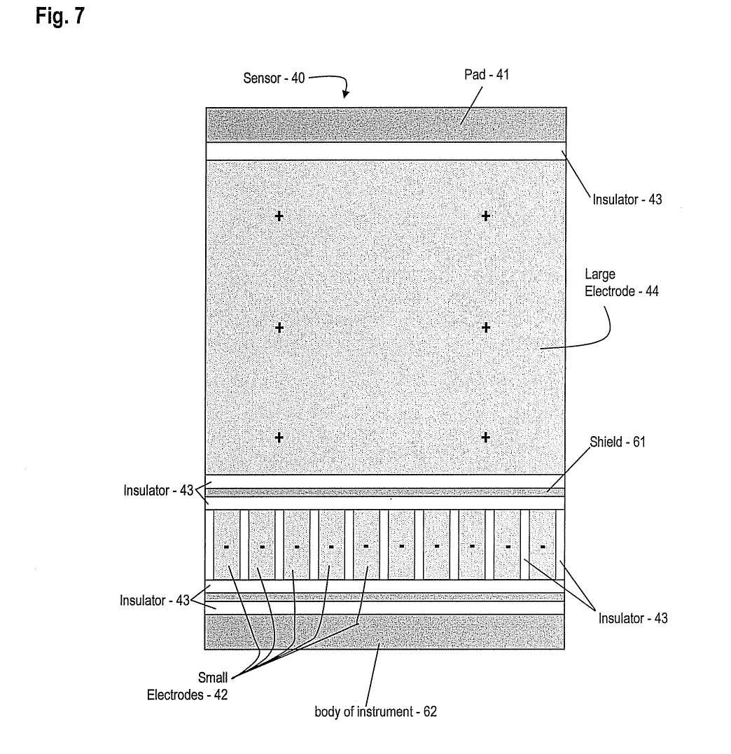

In another embodiment, depicted in FIG. 7, the large electrode 44 is disposed adjacent (near to) the plurality of small electrodes 42. As shown in FIG. 7 and distinguished from the embodiment of FIG. 4, the large electrode 44 does not surround the small electrodes 42. The large electrode 44 may be separated from the small electrodes 42 by the insulator 43 disposed along a boundary of the large electrode 44. The sensor 40 includes an optional shield 61. In this embodiment, the shield 61 provides mechanical stability and an improved image. The improved image is a result of minimizing capacitance between the at least one small electrode 42 and the large electrode 44. In some embodiments, the shield 61 is disposed proximate to the small electrodes 42 to provide desired effects. Typically, thickness for the shield 61 is minimized while providing for mechanical integrity of the pad. The shield 61 typically is formed of metallic materials.

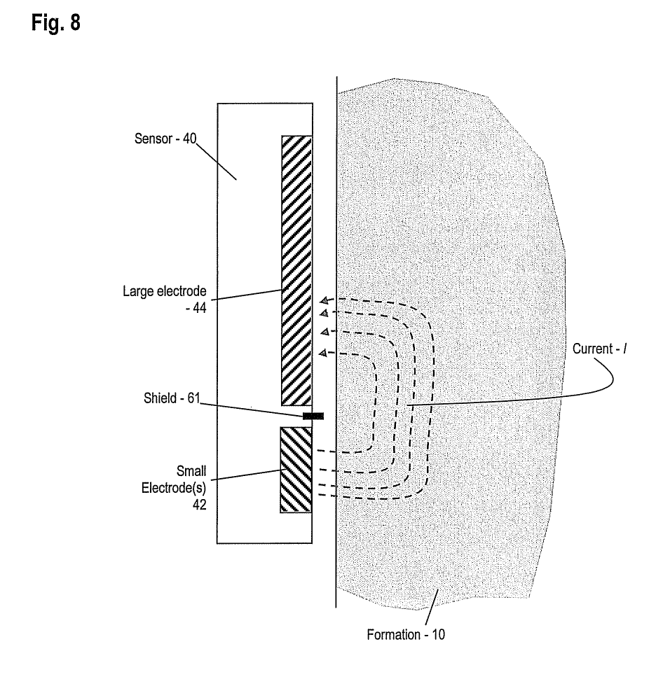

Use of the shield 61 is in contrast to prior art techniques. For example, some prior art techniques use a focusing electrode to affect direction of current entering a sensor electrode from external volumes. That is, employing the focusing electrode forces direction of current perpendicular to the formation 10. In contrast, the shield 61 protects against current leakage by reducing capacitive coupling within the instrument 20, parallel to the formation 10 (reference may be had to FIG. 8). The shield 61 minimizes the cross sectional area whereas a focusing electrode would maximize it.

The illustration of FIG. 8 depicts aspects of the sensor 40 shown in FIG. 7. In FIG. 8, the sensor 40 is shown from a side view (i.e., a cutaway view). The shield 61 provides for an improved signal (current, I) in a direction that is parallel to the formation (i.e., the wellbore 11).

The performance of this shielded embodiment of the sensor 40 was also simulated. The simulation was performed using the same model of the formation 10 as was used for the evaluation of the first embodiment of the sensor 40. The simulation showed results that were similar to the first embodiment, and provided sufficient resolution for separation of layers thicker than about 0.5 inch.

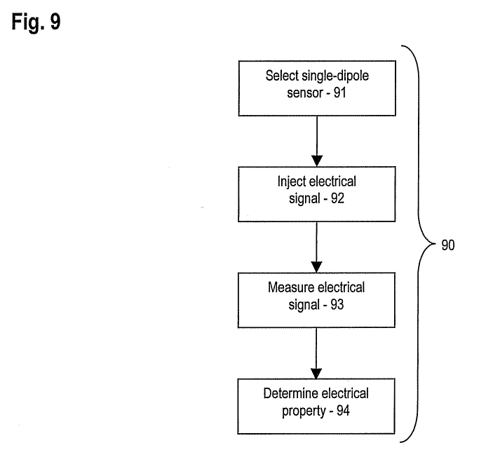

Referring now to FIG. 9, an exemplary method 90 is presented for determining an electrical property of the formation 10. In this method 90, a first step 91 calls for selecting an appropriate sensor 40. In a second step 92, the electrical signal 55 is injected into the formation 10. In a third step 93, the electrical signal 55 through the formation 10 is measured. In a fourth step 94, electrical properties of the formation 10 are determined from the measured signal.

The electrical properties that are determined by resistivity measurements may be used to provide images of the earth formation 10. Accordingly, the instrument 20 disclosed herein provides images of the earth formation 10.

One skilled in the art will recognize that the configurations provided could be easily adapted for measurement-while-drilling (MWD) applications. For example, in MWD (or LWD) applications, a body of the drilling instrument could be used as the large electrode 44 while a single small electrode 42 is provided therein and separated by an insulator 43. Other components, such as a body of the wireline tool, armor of the cable, and similar components may be used as deemed appropriate. In MWD applications, imaging may be performed using a single circumferential large electrode 44 and using the at least one small electrode 42 to perform measurements of the impedance Z_{c}.

Using the sensor 40 for performing phase sensitive measurements of impedance Z_{c} at a relatively high frequency f range provides for increased sensitivity of measurements for resistivity R_{f} of the formation 10 and reduced rugosity and standoff effects.

In operation, the frequency f of the electrical signal 55 may be increased moderately to reduce the capacitive impedance Z_{c} between the electrodes of the sensor 40 the formation 10. Phase of the electrical signal 55 is measured to within one degree accuracy in order to separate the capacitive impedance Z_{c} and the resistivity R_{f}. Multiple frequencies f are used in the electric signal 55 to enable solving for resistivity of the drilling fluid Rₘ.

Varying properties of the current I injected into the formation 10 may be performed to obtain varying forms of data. Current I may be injected into the formation 10 continuously (a constant signal), with a varying frequency f with a varying impedance Z_{c}, in a pulsed manner, in any manner of multiplexing (for example, time, frequency, phase) or with any of several other techniques as known by those skilled in the art.

The HFEI sensor 40 is particularly useful for enabling resistivity imaging in environments where the resistivity R is on the order of or less than the capacitive impedance Z_{c} (between electrodes and the formation).

In support of the teachings herein, various analysis components may be included such as a digital system and/or an analog system having components such as a processor, storage media, memory, input, output, communications link (wired, wireless, optical or other), user interfaces, software programs, signal processors (digital or analog) and other such components (such as resistors, capacitors, inductors and others). It is considered that these teachings may be implemented in conjunction with a set of computer executable instructions stored on a computer readable medium, comprising ROM, RAM, CD ROM, flash or any other computer readable medium, now known or unknown, that when executed cause a computer to implement the method of the present invention. These instructions may provide for equipment operation, control, data collection and analysis and other functions deemed relevant by a system designer, owner, user or other such personnel.

Further, various other components may be included and called upon for providing for aspects of the teachings herein. For example, at least one power supply (e.g., at least one of a generator, a remote supply and a battery), motive force (such as a translational force, propulsional force or a rotational force), sensor, electrode, transmitter, receiver, transceiver, controller, optical unit, electrical unit and electromechanical unit may be included in support of the various aspects discussed herein.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications may be made to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A single-dipole sensor for determining an electrical property of an earth formation, the sensor comprising:
a pad consisting essentially of a body and at least one small electrode separated from a large electrode by an insulator;
wherein an output of the sensor comprises a measurement of an electrical signal through the formation for each small electrode.

2. The single-dipole sensor as in claim 1, wherein the electrical signal comprises a voltage.

3. The single-dipole sensor as in claim 2, wherein the output further comprises a determination of at least one of a current and an impedance.

4. The single-dipole sensor as in claim 1, wherein the electrical signal comprises a current.

5. The single-dipole sensor as in claim 4, wherein the output further comprises a determination of at least one of a voltage and an impedance.

6. The single-dipole sensor as in claim 1, wherein the electrical signal comprises an impedance.

7. The single-dipole sensor as in claim 6, wherein the output further comprises a determination of at least one of a current and a voltage.

8. The single-dipole sensor as in claim 1, wherein a surface area of the large electrode is larger than the surface area of the at least one small electrode.

9. The single-dipole sensor as in claim 1, wherein an impedance between the formation and the large electrode is substantially less than the impedance between the formation and the at least one small electrode.

10. The single-dipole sensor as in claim 9, wherein a surface area of the at least one small electrode provides for a desired impedance between the formation and the at least one small electrode.

11. The single-dipole sensor as in claim 1, wherein a distance between the large electrode and the at least one small electrode is selected to reduce an inductive impedance of a current loop formed between the large electrode and the at least one small electrode.

12. The single-dipole sensor as in claim 1, wherein a surface of selected small electrodes comprise a recess from a surface of the body.

13. The single-dipole sensor as in claim 12, further comprising a dielectric material disposed over selected small electrodes.

14. The single-dipole sensor as in claim 1, wherein the sensor is adapted for deployment by one of a coil tubing, a pipe, a wireline, a drill string and a tractor.

15. A method for determining an electrical property of an earth formation, the method comprising:
using a single-dipole sensor comprising a pad consisting essentially of a body and at least one small electrode separated from a large electrode by an insulator;
injecting an electrical signal into the formation;
measuring the electrical signal through the formation; and
determining the electrical property using the measured signal.

16. The method as in claim 15, wherein measuring comprises measuring between the large electrode and the at least one small electrode at least one of a voltage, a current and an impedance.

17. The method as in claim 15, wherein the electrical property comprises an impedance for the formation by using a ratio of known voltage to measured current.

18. The method as in claim 15, further comprising determining an active component of the measured signal to determine resistivity of the formation.

19. The method as in claim 15, further comprising determining a reactive component of the measured signal to determine resistivity of the formation.

20. The method as in claim 15, wherein the electrical signal comprises at least one frequency between about 100 kHz and about 100 MHz.

21. The method as in claim 15, wherein measuring the signal comprises measuring a phase between a current and a voltage.

22. The method as in claim 15, further comprising determining an electrical property of at least one of a borehole and a non-conductive fluid disposed between the sensor and the formation.

23. The method as in claim 22, wherein the electrical property of the borehole provides an indication of at least one of a rugosity and a shape.

24. A single-dipole sensor for determining an electrical property of an earth formation, the sensor comprising:
a pad comprising a body, at least one small electrode, a large electrode and a shield disposed between the large electrode and the at least one small electrode;
wherein an output of the sensor comprises a measurement of an electrical signal through the formation for each small electrode.

25. The single-dipole sensor as in claim 24, wherein the shield is adapted for reducing capacitance between the large electrode and the at least one small electrode.

26. The single-dipole sensor as in claim 24, wherein the at least one small electrode and the large electrode are separated by an insulator.

27. A method for providing an image of an earth formation, the method comprising:
using a single-dipole sensor comprising a pad consisting essentially of a body and at least one small electrode separated from a large electrode by an insulator;
injecting an electrical signal into the formation;
measuring the electrical signal through the formation; and
providing the image of the earth formation from the measurements.
